(19) United States
(12) Patent Application Publication
(10) Pub. No.: US 2025/0292533 A1
(43) Pub. Date: Sep. 18, 2025

(54) MATERIAL EXTRACTION METHOD AND APPARATUS, DEVICE AND STORAGE MEDIUM

(71) Applicant: Tencent Technology (Shenzhen) Company Limited, Shenzhen (CN)

(72) Inventors: Yundong ZHANG, Shenzhen (CN); Hong SHANG, Shenzhen (CN); Bishan WANG, Shenzhen (CN); Jiawen ZHENG, Shenzhen (CN); Zhongqian SUN, Shenzhen (CN)

(73) Assignee: Tencent Technology (Shenzhen) Company Limited, Shenzhen (CN)

(21) Appl. No.: 19/223,911

(22) Filed: May 30, 2025

Related U.S. Application Data
(63) Continuation of application No. PCT/CN2024/087907, filed on Apr. 16, 2024.

(30) Foreign Application Priority Data
Jun. 14, 2023 (JP) 202310708769.8

(51) Int. Cl. G06V 10/44; G06T 11/00; G06V 10/26; G06V 10/54

(52) U.S. Cl. CPC G06V 10/44; G06T 11/001; G06V 10/26; G06V 10/54

(57) ABSTRACT

A method, apparatus, and computer-readable storage medium for extracting material information from images. The method segments an image to obtain an object segmentation area representing non-background areas, which is then divided into multiple image blocks. Feature mutual information is calculated between every pair of image blocks to determine an object image block from among the divided blocks. Based on the identified object image block, material information associated with the object is extracted. This computational approach enables automated material information extraction through image analysis, providing an efficient method for identifying and characterizing objects in images without manual intervention.

### CROSS-REFERENCE TO RELATED APPLICATIONS

This application is a continuation application of International Application No. PCT/CN2024/087907 filed on Apr. 16, 2024 which claims priority to Chinese Patent Application No. 202310708769.8, filed with the China National Intellectual Property Administration on Jun. 14, 2023, the disclosures of each being incorporated by reference herein in their entireties.

### FIELD

The disclosure relates to the technical field of artificial intelligence, a material extraction method and apparatus, a device, and a storage medium.

### BACKGROUND

With the rapid development of artificial intelligence (AI) technology, it can be increasingly well applied to construction of buildings in a plurality of scenes such as a virtual scene or a physical scene. During construction of a building, a main structure of the building, namely, a building facade, typically includes structures such as a wall, a window, a balcony, and a decoration, can determine a main style and purpose of the building, and is the most critical part of building design. Therefore, analysis of the building facade may play an important role in construction of a scene such as a virtual scene or a physical scene, and has attracted wide attention.

The wall is the most common element in the building. Different wall materials determine an overall style of the wall, and have a significant impact on a purpose, such as lighting and heat dissipation, of the building. Therefore, how to efficiently and rapidly extract a wall material from a building picture is an important problem that may be solved urgently currently.

In the related art, according to a common material classification method, a relatively representative wall area block is usually extracted from a target picture by manual experience-based screening, the screened wall area block is transmitted to a trained neural network classifier to output a wall material classification result, and a most matched wall material is determined based on the classification result. However, according to this method, the relatively representative wall area block can be extracted from the target image only by manual experience-based screening, which is susceptible to manual experience, increases interference in subsequent material extraction, and affects efficiency and accuracy of material extraction. As a result, it is difficult to achieve high-precision reconstruction of a building wall based on the extracted wall material.

### SUMMARY

Provided are a method and apparatus for extracting material information, a device, a storage medium, and a program product, which can implement efficient identification and extraction of material information from images through segmentation and feature mutual information analysis.

According to some embodiments, a method for extracting material information, performed by a computer device, includes: segmenting an image to obtain an object segmentation area representing a non-background area in the image; dividing the object segmentation area into N image blocks, N being an integer greater than 1; calculating feature mutual information between every two of the N image blocks; determining an object image block from the N image blocks based on the feature mutual information; and extracting, based on the object image block, material information associated with an object in the object image block.

According to some embodiments, an apparatus for extracting material information, includes: at least one memory configured to store program code; and at least one processor configured to read the program code and operate as instructed by the program code, the program code including: segmenting code configured to cause at least one of the at least one processor to segment an image to obtain an object segmentation area representing a non-background area in the image; dividing code configured to cause at least one of the at least one processor to divide the object segmentation area into N image blocks, N being an integer greater than 1; calculating code configured to cause at least one of the at least one processor to calculate feature mutual information between every two of the N image blocks; determining code configured to cause at least one of the at least one processor to determine an object image block from the N image blocks based on the feature mutual information; and extracting code configured to cause at least one of the at least one processor to extract, based on the object image block, material information associated with an object in the object image block.

According to some embodiments, a non-transitory computer-readable storage medium, storing computer code which, when executed by at least one processor, causes the at least one processor to at least: segment an image to obtain an object segmentation area representing a non-background area in the image; divide the object segmentation area into N image blocks, N being an integer greater than 1; calculate feature mutual information between every two of the N image blocks; determine an object image block from the N image blocks based on the feature mutual information; and extract, based on the object image block, material information associated with an object in the object image block.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic architectural diagram of an image data processing system according to some embodiments.

FIG. 2 is a flowchart of a material extraction method according to some embodiments.

FIG. 3 is another flowchart of a material extraction method according to some embodiments.

FIG. 4 is another flowchart of a material extraction method according to some embodiments.

FIG. 5 is another flowchart of a material extraction method according to some embodiments.

FIG. 6 is another flowchart a material extraction method according to some embodiments.

FIG. 7 is another flowchart of a material extraction method according to some embodiments.

FIG. 8 is another flowchart of a material extraction method according to some embodiments.

FIG. 9 is another flowchart of a material extraction method according to some embodiments.

FIG. 10 is another flowchart of a material extraction method according to some embodiments.

FIG. 11 is another flowchart of a material extraction method according to some embodiments.

FIG. 12 is another flowchart of a material extraction method according to some embodiments.

FIG. 13 is another flowchart of a material extraction method according to some embodiments.

FIG. 14 is a schematic principle flowchart of a material extraction method according to some embodiments.

FIG. 15 is another schematic principle flowchart of a material extraction method according to some embodiments.

FIG. 16 is a schematic diagram of a material extraction apparatus according to some embodiments.

FIG. 17 is a schematic diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments provide a material extraction method and apparatus, a device, and a storage medium, to quickly and accurately determine an object image block based on feature mutual information, without the need for manual experience-based screening, avoid the impact of manual experience, reduce interference in subsequent material extraction, and then improve efficiency and accuracy of material extraction. In this way, high-precision reconstruction is achieved.

The terms such as “first”, “second”, “third”, and “fourth” (if any) in the description, the claims, and the drawings of this application are used for distinguishing similar objects and not necessarily used for describing any particular order or sequence. It is to be understood that data used in this way is exchangeable in a proper case, whereby the embodiments of the present disclosure described herein can be implemented in an order different from the order shown or described herein. In addition, the terms “include”, “corresponding to” and any other variants are intended to cover the non-exclusive inclusion. For example, a process, method, system, product, or device that includes a series of steps or units is not necessarily limited to those expressly listed steps or units, but may include other steps or units not expressly listed or inherent to such a process, method, product, or device.

In some embodiments, relevant data, such as the to-be-processed image and feature mutual information, is involved. When the foregoing embodiments of this application are applied to a product or technology with user permission or user consent, and collection, use, and processing of the relevant data need to comply with relevant laws and regulations and standards of relevant countries and regions.

For ease of understanding, the following interprets related terms or concepts in some embodiments.
1. Building facade: A building in most scenes (such as a game scene or a household design scene) may be roughly divided into three parts: a building roof, a building facade, and a building bottom layer. The building facade is a main structure of the building, and typically includes structures such as a wall, a window, a balcony, and a decoration. The building facade determines a style and purpose of the building, and is the most critical part of building design. Therefore, analysis of the building facade may play an important role in construction of a scene such as urban planning, energy utilization, a virtual scene, or a physical scene.
2. Wall material: The wall is the most common element in the building, and a wall material is a building material of the wall. Common wall materials include marble (mostly found in European-style buildings), concrete (modern new buildings), red bricks (houses), wooden boards, and the like. Different wall materials determine an overall style of the wall, and have a significant impact on lighting, heat dissipation, and the like of the building.
3. Unreal engine (UE): A UE is an engine frequently used in game production, movie and television rendering, and graphic effects. The UE may represent different objects by using a material. The material is a UE material, and different materials are composed of different parameters such as a color, roughness, metallicity, a normal map, and texture.

The material extraction method further relates to the artificial intelligence (AI) technology, and material extraction is automatically implemented by using the AI technology.

With the research and progress of the AI technology, it has been researched and applied to fields of common smart homes, smart wearable devices, virtual assistants, smart speakers, intelligent marketing, unmanned driving, autonomous driving, unmanned aerial vehicles, robots, smart healthcare, intelligent customer service, and the like. It is believed that with the development of the technology, the AI technology will be applied to more fields, and plays an increasingly important role.

The material extraction method provided in this application may be applied to various scenarios, which include, but are not limited to, AI, a cloud technology, a map, intelligent traffic, and the like. According to the material extraction method, an object image block is determined based on feature mutual information between every two of N to-be-processed image blocks in an object segmentation area, to quickly select the object image block representing an object, and then material extraction is performed based on the object image block, to obtain a material of the object included in the object image block. In this way, high-precision reconstruction of a virtual model can be achieved subsequently based on the material of the object. Therefore, the material extraction method can be applied to a scene such as a virtual game construction scene, a smart home construction scene, and a smart urban building scene.

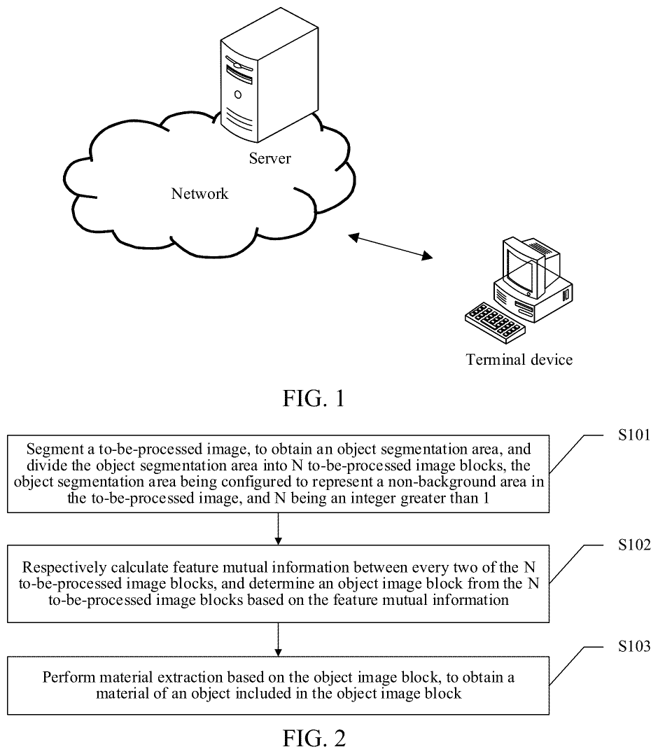

To solve the foregoing problem, this application provides a material extraction method. The method is applied to a data object control system shown in FIG. 1. FIG. 1 is a schematic architectural diagram of a data object control system according to some embodiments. As shown in FIG. 1, a server segments a to-be-processed image provided by a terminal device, to obtain a non-background area, namely, an object segmentation area, in the to-be-processed image, then divides the object segmentation area into N to-be-processed image blocks, and respectively calculates feature mutual information between every two to-be-processed image blocks. The feature mutual information may reflect a similarity between any image block and another image block, and further reflect whether the image block may represent an object. In this way, an object image block may be determined from the N to-be-processed image blocks based on the feature mutual information. The object image block is an image block that can represent an object such as a wall. Then, material extraction is performed based on the object image block, to obtain a material of the object included in the object image block. According to the foregoing method, the feature mutual information between every two of the N to-be-processed image blocks in the object segmentation area can be calculated. That is, the object image block can be quickly and accurately determined based on the feature mutual information, without the need for manual experience-based screening, to avoid the impact of manual experience, reduce interference in subsequent material extraction, and then improve efficiency and accuracy of material extraction. In this way, high-precision reconstruction is achieved.

FIG. 1 shows the terminal device. In an actual scenario, more types of terminal devices may participate in the process of data processing. The terminal device includes, but is not limited to, a mobile phone, a computer, a smart speech interaction device, a smart home appliance, an on-board terminal, and the like. A quantity and a type are determined according to the actual scenario, and are not limited herein. In addition, FIG. 1 shows one server. However, in an actual scenario, a plurality of servers may be involved, and in a scenario of multi-model training and interaction, a quantity of servers is determined according to the actual scenario, and is not limited herein.

In some embodiments, the server may be an independent physical server, or may be a server cluster or distributed system that includes a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), and a big data and AI platform. The terminal device and the server may be connected directly or indirectly by using a wired or wireless communication protocol.

With reference to the foregoing description, the material extraction method in this application is described below. Refer to FIG. 2. In some embodiments, a material extraction method includes:
S101: Segment a to-be-processed image, to obtain an object segmentation area, and divide the object segmentation area into N to-be-processed image blocks, the object segmentation area being configured to represent a non-background area in the to-be-processed image, and N being an integer greater than 1.

The to-be-processed image is an image on which material extraction may be performed. The to-be-processed image includes an object, and material extraction is to obtain a material of the object. A type of the object is not limited. For example, the object is a wall. In some embodiments, when material extraction may be performed on the to-be-processed image, the to-be-processed image may be first segmented, to obtain the non-background area, namely, the object segmentation area, in the to-be-processed image, and then the object segmentation area may be divided into the N to-be-processed image blocks. In this way, an object image block that can represent the to-be-processed image may be subsequently extracted from the N to-be-processed image blocks.

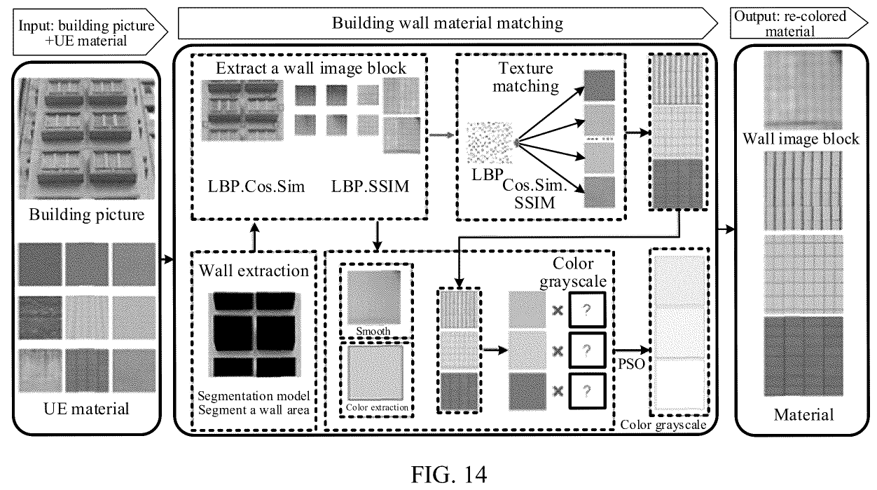

As shown in FIG. 14, for example, it is assumed that the to-be-processed image is a building picture in a game virtual building scene, and the object is a wall, the to-be-processed image (such as a building picture of an building shown in FIG. 14, which includes a wall, a window, and the like) may be first inputted into a segmentation model (such as a U-net full convolutional neural network for image segmentation), and a background area (such as a deleted window area shown in FIG. 14) and a non-background area (such as a wall area from which a window is deleted) are segmented, to obtain an object segmentation area (such as a wall area from which the background area such as the window is deleted in a wall extraction module shown in FIG. 14).

In some embodiments, a pixel value of the background area (namely, a non-wall area) in the to-be-processed image is set to zero (that is, masked), which facilitate subsequent extraction of an object image block (namely, an image block that can represent the wall).

Because a building wall in an actual scenario is basically made from one type of material, it may be considered that the object segmentation area (namely, a wall area) in the to-be-processed image is uniform. Therefore, material extraction may be performed on one area, namely, the object image block (namely, the image block that can represent the wall), to extract a material corresponding to the to-be-processed image. Based on this, in some embodiments, after the object segmentation area is acquired, image blocks of a size (such as 32×32) may be sampled from the object segmentation area (namely, the segmented wall area) in a sequence from top to bottom and from left to right, and are denoted as Pi, where i=1, 2, . . . , N, and N is a total quantity of image blocks. In this way, the object image block (namely, the image block that can represent the wall) can be selected from these image blocks subsequently.
S102: Respectively calculate feature mutual information between every two of the N to-be-processed image blocks, and determine an object image block from the N to-be-processed image blocks based on the feature mutual information.

Due to the impact of factors, such as a lighting condition, a camera shooting angle, and a picture resolution, in an actual scenario, the object segmentation area (namely, the wall area) of the to-be-processed image is susceptible to noise interference caused by a plurality of factors. Therefore, to better extract the object image block (namely, the image block that can represent the wall) from the object segmentation area (namely, the wall area) and facilitate subsequent material extraction for the object image block (namely, the image block that can represent the wall), after the N to-be-processed image blocks are acquired, the feature mutual information between every two to-be-processed image blocks may be respectively calculated. The feature mutual information may reflect a similarity between any image block and another image block, and further reflect whether the image block may represent an object. Then, the object image block may be better selected from the N to-be-processed image blocks based on the feature mutual information.

After the N to-be-processed image blocks are acquired, the feature mutual information between every two to-be-processed image blocks may be respectively calculated. In some embodiments, the feature mutual information may include a texture feature similarity. In this case, a texture feature of each to-be-processed image block may be first calculated by using a local binary pattern (LBP) feature algorithm, and then the texture feature similarity (such as a cosine similarity and structural similarity (SSIM) algorithm) between every two to-be-processed image blocks may be calculated based on the texture feature of each to-be-processed image block, and taken as the feature mutual information between the image blocks.

When the feature mutual information includes the texture feature similarity, an implementation of S102 may be as follows: first, the texture feature of each to-be-processed image block is calculated based on a pixel value of each pixel in each to-be-processed image block. Because the image block (such as a wall) representing the to-be-processed image may be defined as an image block having a highest similarity with all other image blocks (such as wall blocks), a sum of texture feature similarities between each to-be-processed image block and the other N−1 to-be-processed image blocks may be respectively calculated, and a to-be-processed image block corresponding to a largest sum is taken as the object image block. For example, the object included in the to-be-processed image is a wall, the to-be-processed image block may be a wall block. Therefore, a sum of similarities between any wall block and all other blocks may be calculated, and a to-be-processed image block corresponding to a maximum sum, namely, a to-be-processed image block corresponding to a largest sum of the texture feature similarities, is taken as the object image block.

The algorithm for extracting the texture feature of each to-be-processed image block is not limited to the LBP image feature algorithm, and other image feature descriptors, such as a scale-invariant feature transform (SIFT) algorithm, an oriented FAST and rotated BRIEF (ORB) algorithm, and an image feature extracted based on a neural network, may be used.

The method for calculating the feature mutual information between the to-be-processed image blocks may be not limited to the single-scale cosine similarity and SSIM algorithm, and other methods, such as a mean square error, a peak signal-to-noise ratio, and a multi-scale similarity measurement, may be adopted to measure the mutual information of the blocks.
S103: Perform material extraction based on the object image block, to obtain a material of an object included in the object image block.

After the object image block that can represent the object is obtained, material extraction may be directly performed on the object image block, to obtain the material of the object included in the object image block.

The to-be-processed image is segmented, to obtain the non-background area, namely, the object segmentation area, in the to-be-processed image. Then, the object segmentation area is divided into the N to-be-processed image blocks, and the feature mutual information between every two to-be-processed image blocks is calculated. The feature mutual information may reflect a similarity between any image block and another image block, and further reflect whether the image block may represent an object. In this way, the object image block may be determined from the N to-be-processed image blocks based on the feature mutual information. The object image block is the image block that can represent the object such as a wall. Then, material extraction is performed based on the object image block, to obtain the material of the object included in the object image block. According to the foregoing method, the feature mutual information between every two of the N to-be-processed image blocks in the object segmentation area can be calculated. That is, the object image block can be quickly and accurately determined based on the feature mutual information, without the need for manual experience-based screening, to avoid the impact of manual experience, reduce interference in subsequent material extraction, and then improve efficiency and accuracy of material extraction. In this way, high-precision reconstruction is achieved.

In some embodiments, a material extraction method is not limited. In some embodiments, material classification may be performed based on the object image block by using a neural network classifier to obtain the material of the object.

In some embodiments, to avoid training the neural network classifier for material classification, in S103, a method for performing material extraction based on the object image block to obtain a material of an object included in the object image block may be (not shown in the figure):
S201: Respectively perform texture matching on the object image block and each candidate material image in a candidate material image set, to obtain a texture matching result corresponding to each candidate material image.
S202: Determine an object material image from the candidate material image set based on the texture matching result corresponding to each candidate material image, the object material image being configured to represent the material of the object included in the object image block.

In some embodiments, after the object image block is acquired, texture matching may be respectively performed on the object image block and each candidate material image in the candidate material image set, to obtain the texture matching result corresponding to each candidate material image. The texture matching result may reflect whether the candidate material image is similar to a texture of a material of the object image block. In this way, the candidate material image that is the most similar to the object image block may be found based on the texture matching result subsequently.

The candidate material image set is created based on a UE and can represent materials of various different objects (such as various walls in a game virtual building scene). Different materials are composed of different parameters such as a color, roughness, metallicity, a normal map, and texture. A UE material may be understood as a material. The UE material may be assigned to a virtual model, whereby a color and texture of the virtual model are consistent with the material. In this way, high-fidelity reconstruction of the model is achieved. In addition, the UE material may be assigned to a plane. Therefore, a generated plane is a material image, namely, the candidate material image.

A management object or a design object (such as a game scene building designer in a game virtual construction scene) may further increase or reduce the UE materials in the candidate material image set according to an actual application requirement, without re-adjusting calculation parameters of various models, to quickly adapt to requirements of various scene services.

As shown in FIG. 14, for example, it is assumed that the to-be-processed image is a building picture in a game virtual building scene, and it is assumed that the extracted object image block is the wall image block shown in FIG. 14, a candidate material image set related to wall materials are searched from the UE.

A texture matching module shown in FIG. 14 may respectively perform texture matching on the acquired object image block and each candidate material image in the candidate material image set. Specifically, a material texture feature of each candidate material image may be first calculated based on a pixel value of each pixel in each candidate material image and by using an LBP feature algorithm, and then a texture feature similarity (such as a cosine similarity and an SSIM) between the object image block and each candidate material image may be respectively calculated based on the texture feature of the object image block and the material texture feature of each candidate material image. The texture feature similarity is taken as the texture matching result corresponding to each candidate material image.

The algorithm for extracting the material texture feature of each candidate material image is not limited to the LBP feature algorithm, and other image feature descriptors such as an SIFT algorithm, an ORB algorithm, and an image feature extracted based on a neural network may be used.

In some embodiments, after the texture matching result corresponding to each candidate material image is acquired, an optimal matched material image, that is, an object material image, may be selected from the candidate material image set based on the texture matching result corresponding to each candidate material image.

When the texture matching result is the texture feature similarity, after the texture matching result corresponding to each candidate material image is acquired, a candidate material image corresponding to a texture feature similarity having a maximum value may be selected as the object material image based on the texture matching result corresponding to each candidate material image.

In an actual application process, in some embodiments, first three texture matching results are further returned (for example, as shown in FIG. 14, the texture matching module returns first three texture matching results such as three candidate material images of different materials), and the management object or the design object (such as the game scene building designer in the game virtual construction scene) corrects the acquired first three texture matching results or makes a better matching selection based on an actual application scenario, to acquire the optimal matched object material image.

According to the foregoing method, the object material image is directly screened by texture matching, and a model that can perform material classification on a target image block does not need to be trained. This not only can effectively reduce material extraction costs, but also can achieve simply deploy and low calculation complexity. Therefore, efficiency of material extraction can be improved. In addition, by respectively performing texture matching on the object image block and each candidate material image in the candidate material image set, not only the object material image can be accurately extracted, but also important information such as a texture attribute of a material can be learned based on texture allocation. In this way, high-fidelity reconstruction of the virtual model can be implemented subsequently based on the texture attribute of the object material image in a downstream use scenario.

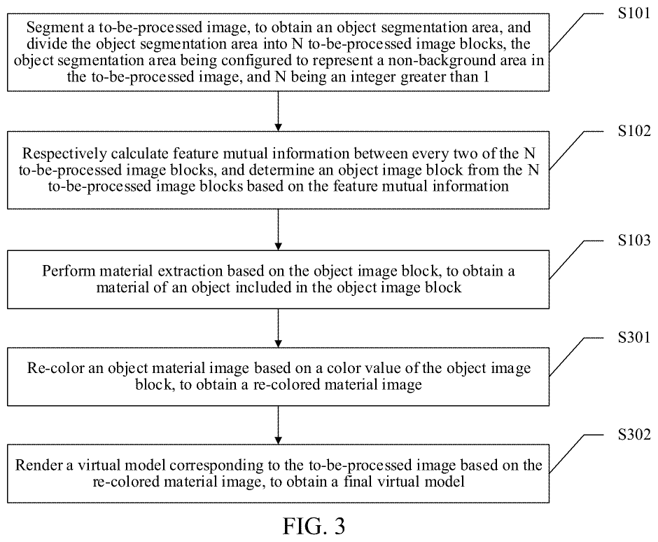

Based on the foregoing embodiment corresponding to FIG. 2, in another embodiment of the material extraction method provided in some embodiments, as shown in FIG. 3, after the operation of determining an object material image from the candidate material image set based on the texture matching result corresponding to each candidate material image, the method further includes:
S301: Re-color the object material image based on a color value of the object image block, to obtain a re-colored material image.
S302: Render a virtual model corresponding to the to-be-processed image based on the re-colored material image, to obtain a final virtual model.

The matched object material image (namely, the UE material) and the object image block are consistent in texture, but may still have a large difference in color. Therefore, in some embodiments, the object material image may be re-colored based on the color value of the object image block, to obtain the re-colored material image. That is, the re-colored material image consistent in texture and color with the object image block may be obtained. Subsequently, the virtual model corresponding to the to-be-processed image may be rendered based on the re-colored material image, to obtain the final virtual model. In this way, high-precision high-fidelity reconstruction of the final virtual model may be achieved.

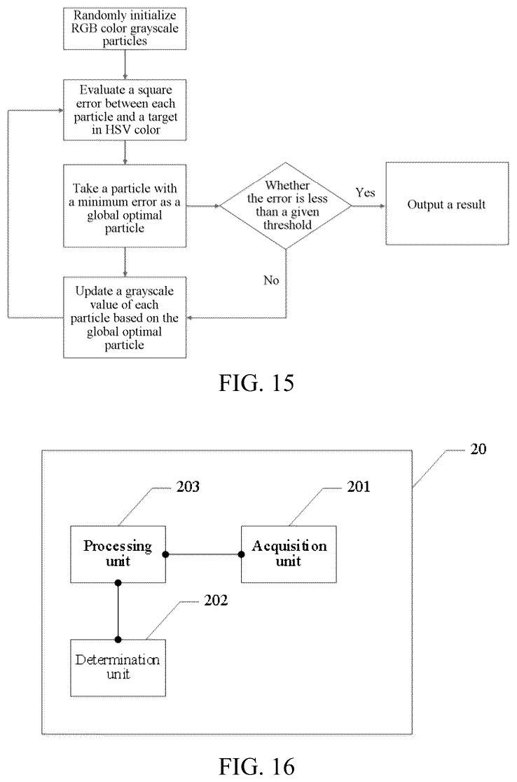

As shown in FIG. 14, for example, the texture matching module returns the texture matching result, the color of the object image block may be compared with the color of the object material image (namely, the UE material), and the object material image is re-colored based on the color value of the object image block. Specifically, the object material image (namely, the UE material) may be re-colored by calculating a color adjustment grayscale, that is, the object image block is smoothed, to acquire a color value corresponding to each pixel in the object image block, and a color average value of the object image block is calculated based on the color value corresponding to each pixel in the object image block. Then, based on the color average value of the object image block, as shown in FIG. 15, a to-be-used color grayscale particle is determined from M randomly initialized color grayscale particles, and then a color grayscale value of the to-be-used color grayscale particle is multiplied by the color value of the object material image. For example, the object material image is denoted as m whose Red-Green-Blue (RGB) color channel values are (R, G, B), and the UE engine re-colors the object material image by multiplying one RGB color grayscale triplet P=(a, b, c) of the to-be-used color grayscale particle (where 0≤a, b, c≤1) by the color of the object material object, to obtain a re-coloration result f=p*m=(R*a, G*b, B*c), and then, assigns a re-coloration value f to the object material image, to obtain the re-colored material image. In this way, a finally obtained re-colored material image and the object image block have a consistent visual effect (that is, a texture and a color are consistent).

In some embodiments, the virtual model corresponding to the to-be-processed image may be rendered based on the re-colored material image. Specifically, the re-colored material image may be assigned, based on the virtual engine UE, to a building model that is modeled in advance (which may be understood as providing a color to the building model), to acquire the final virtual model. In this way, high-fidelity reconstruction of the virtual model is achieved.

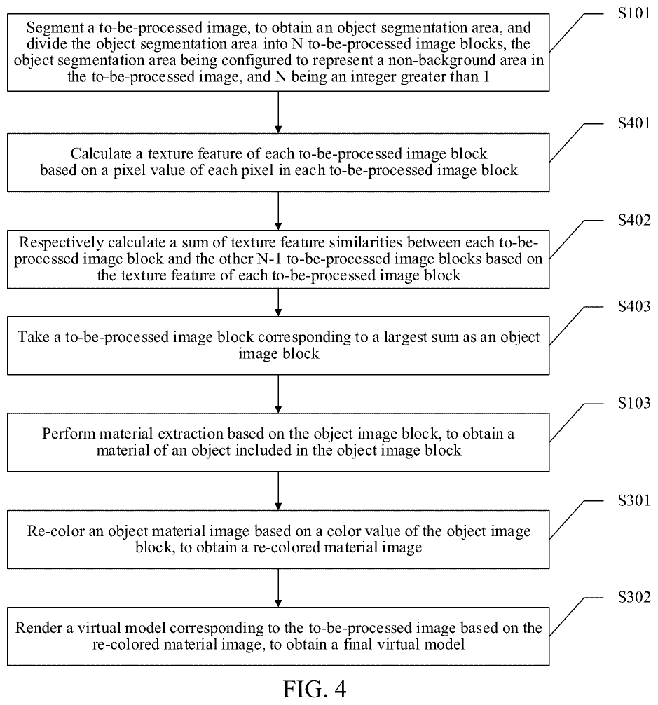

Based on the foregoing embodiment corresponding to FIG. 2, in another embodiment of the material extraction method provided in some embodiments, as shown in FIG. 4, the feature mutual information includes a texture feature similarity; and operation S102 of respectively calculating feature mutual information between every two of the N to-be-processed image blocks, and determining an object image block from the N to-be-processed image blocks based on the feature mutual information includes:
S401: Calculate a texture feature of each to-be-processed image block based on a pixel value of each pixel in each to-be-processed image block.
S402: Respectively calculate a sum of texture feature similarities between each to-be-processed image block and the other N−1 to-be-processed image blocks based on the texture feature of each to-be-processed image block.
S403: Take a to-be-processed image block corresponding to a largest sum as the object image block.

In some embodiments, after the N to-be-processed image blocks are acquired, the texture feature of each to-be-processed image block may be calculated based on the pixel value of each pixel in each to-be-processed image block, and further, the sum of the texture feature similarities between each to-be-processed image block and the other N−1 to-be-processed image blocks may be respectively calculated based on the texture feature of each to-be-processed image block. Then, the to-be-processed image block corresponding to the largest sum is taken as the object image block. Therefore, a most representative to-be-processed image block may be selected from the N to-be-processed image blocks as the object image block based on important information such as a texture attribute. In this way, accuracy of material extraction is improved.

In some embodiments, a method for calculating the texture feature of each to-be-processed image block based on the pixel value of each pixel in each to-be-processed image block may be as follows: first, each pixel (such as a pixel K) of each processing image block is taken as a circle center and a radius threshold (such as a radius R) is taken as a radius, and a first associated pixel of each pixel within the radius in the to-be-processed image block is traversed; further, a local feature value corresponding to each pixel is calculated by using the LBP feature algorithm based on the pixel value of each pixel and a pixel value of the first associated pixel of each pixel; and then, the local feature value of each pixel is organized to obtain the texture feature of each to-be-processed image block.

After the texture feature of each to-be-processed image block is acquired, the texture feature similarities (such as cosine similarities and SSIMs) between each to-be-processed image block and the other N−1 to-be-processed image blocks may be calculated based on the texture feature of each to-be-processed image block, and the sum of the texture feature similarities between each to-be-processed image block and the other N−1 to-be-processed image blocks is calculated. Then, the to-be-processed image block corresponding to the sum of texture feature similarities having a maximum value, namely, an image block having a highest similarity with all other wall blocks, may be taken as the object image block.

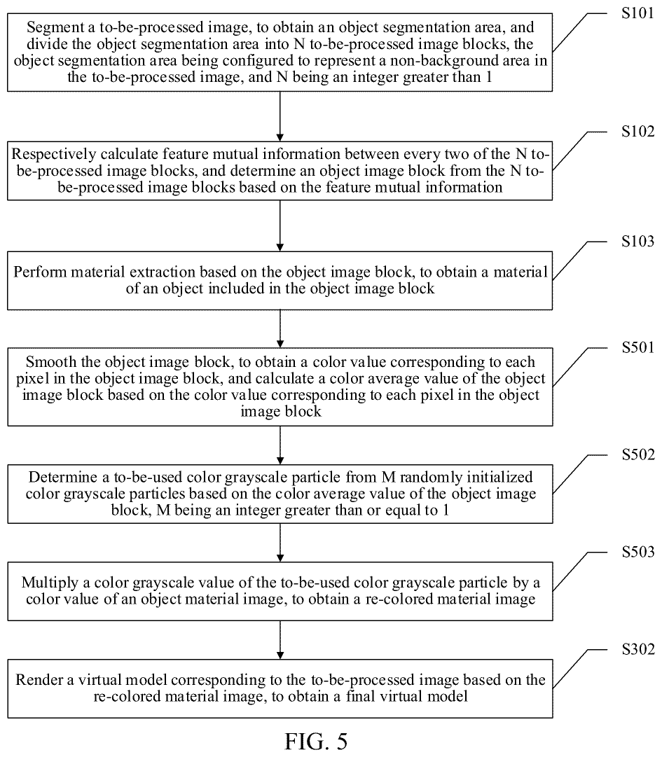

Based on the foregoing embodiment corresponding to FIG. 3, in another embodiment of the material extraction method provided in some embodiments, as shown in FIG. 5, operation S301 of re-coloring the object material image based on a color value of the object image block, to obtain a re-colored material image includes:
S501: Smooth the object image block, to obtain a color value corresponding to each pixel in the object image block, and calculate a color average value of the object image block based on the color value corresponding to each pixel in the object image block.
S502: Determine a to-be-used color grayscale particle from M randomly initialized color grayscale particles based on the color average value of the object image block, M being an integer greater than or equal to 1.
S503: Multiply a color grayscale value of the to-be-used color grayscale particle by a color value of the object material image, to obtain the re-colored material image.

Because the matched object material image (namely, the UE material) and the object image block are consistent in texture, but may still have a large difference in color, in some embodiments, the object image block may be first smoothed, to obtain the color value corresponding to each pixel in the object image block, and the color average value of the object image block is calculated based on the color value corresponding to each pixel in the object image block. Then, the to-be-used color grayscale particle is determined based on the color average value of the object image block from the M randomly initialized color grayscale particles, and the color grayscale value of the to-be-used color grayscale particle is multiplied by the color value of the object material image, to obtain the re-colored material image.

By performing re-coloration in the foregoing manner, the re-colored material image consistent with the object image block in texture and color may be obtained. Subsequently, the virtual model corresponding to the to-be-processed image may be rendered based on the re-colored material image, to obtain the final virtual model. In this way, high-precision high-fidelity reconstruction of the final virtual model is achieved.

In some embodiments, a method for calculating the color average value of the object image block may be as follows: Gaussian denoising is first performed on the object image block (namely, an image block r) by using a Gaussian filtering algorithm, to obtain a blurry image corresponding to a denoised pixel value; and then a color value corresponding to a pixel in each blurry image may be directly acquired based on the blurry image. For example, a color value of a pixel i in the blurry image obtained by denoising the object image block is (ri, gi, bi), and then the color average value of the object image block is calculated based on the color value corresponding to each pixel in the object image block. Specifically, a sum of the color values of all pixels is calculated, and the sum is divided by the total quantity of pixels, to obtain the color average value average (sum (ri), sum (gi), sum (bi)).

As shown in FIG. 15, first, the M color grayscale particles may be randomly initialized; further, a square error between the color average value of the object image block and a current color grayscale value of each color grayscale particle is respectively calculated, to obtain a current moment error corresponding to each color grayscale particle; and then the current moment error may be compared with an error threshold, and if a minimum current moment error is less than the error threshold, a color grayscale particle corresponding to the minimum current moment error may be determined as the to-be-used color grayscale particle.

Next, the color grayscale value of the to-be-used color grayscale particle may be multiplied by the color value of the object material image, to obtain a re-coloration result, and then the object material image is colored based on the re-coloration result, to obtain the re-colored material image.

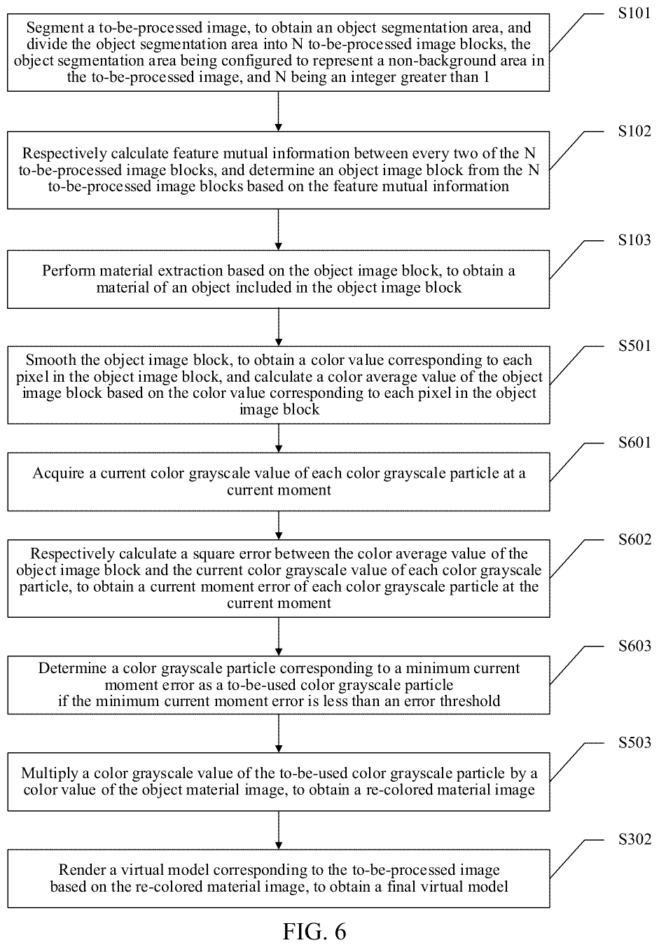

Based on the foregoing embodiment corresponding to FIG. 5, in another embodiment of the material extraction method provided in some embodiments, as shown in FIG. 6, operation S502 of determining a to-be-used color grayscale particle from M randomly initialized color grayscale particles based on the color average value of the object image block includes:
S601: Acquire a current color grayscale value of each color grayscale particle at a current moment.
S602: Respectively calculate a square error between the color average value of the object image block and the current color grayscale value of each color grayscale particle, to obtain a current moment error of each color grayscale particle at the current moment.
S603: Determine a color grayscale particle corresponding to a minimum current moment error as the to-be-used color grayscale particle if the minimum current moment error is less than an error threshold.

In some embodiments, first, the M color grayscale particles may be randomly initialized, and the current color grayscale value of each color grayscale particle at the current moment is acquired; further, the square error between the color average value of the object image block and the current color grayscale value of each color grayscale particle is respectively calculated, to obtain the current moment error of each color grayscale particle at the current moment; and then the current moment error may be compared with the error threshold, and if the minimum current moment error is less than the error threshold, the color grayscale particle corresponding to the minimum current moment error may be determined as the to-be-used color grayscale particle. Therefore, a relatively accurate to-be-used color grayscale particle may be determined from the M color grayscale particles, and re-coloration is performed by using the to-be-used color grayscale particle, to obtain the re-colored material image consistent with the object image block in color.

A similarity between two colors in human visual perception may be expressed through the similarity between the two colors in a Hue-Saturation-Value (HSV) color space, and two colors that are most similar may be expressed by using a least square error represented by formula (1):

$${arg min}_{a , b , c} {( h ( p ) - h ( v ) )}^{2} ; 0 \leq a , b , c \leq 1 , \qquad ( 1 )$$

where v represents an RGB color value of an object image block r, and may be obtained by calculating a color average value of the object image block subjected to Gaussian smoothing; p represents an RGB color triplet of the color grayscale value of the color grayscale particle, such as (a, b, c); and h(·) is a color conversion function configured to convert an input RGB color triplet into an HSV color triplet.

To better find a color grayscale particle most similar to or consistent with the object image block in color, and better re-color the object material image, in some embodiments, as shown in FIG. 15, M RGB color grayscale particles are first randomly initialized by using a particle swarm optimization (PSO) algorithm. For example, M (for example, M>100) particles are randomly initialized. Any color grayscale particle i at the current moment corresponds to one set of RGB color grayscale values pᵢ^{t}=(aᵢ, bᵢ, cᵢ), where the superscript t=0 represents a current initialization moment 0. Further, the square error (h(pᵢ^{t})−h(v))² between each color grayscale particle and the object image block on the HSV color may be calculated based on formula (2). Then, a score sᵢ^{t}=−(h(pᵢ^{t})−h(v))² of each particle i at the current moment may be evaluated based on the square error, and is configured to determine a similarity between the color of each color grayscale particle and the color of the object image block in the HSV color space. Further, a color grayscale particle with a largest score may be found as a current global optimal estimated particle, namely, gₜ=argmaxᵢ(sᵢ^{t}). A color grayscale particle having a minimum current moment error (namely, a minimum square error at the current moment) may be found as the current global optimal estimated particle, namely, gₜ=argminᵢ(h(pᵢ^{t})−h(v))².

As shown in FIG. 15, after the current global optimal estimated particle is found, the minimum current moment error may be compared with the error threshold, and if the minimum current moment error is less than the error threshold, the current global optimal estimated particle is the color grayscale particle that is most similar to or consistent with the object image block in color, namely, the to-be-used color grayscale particle.

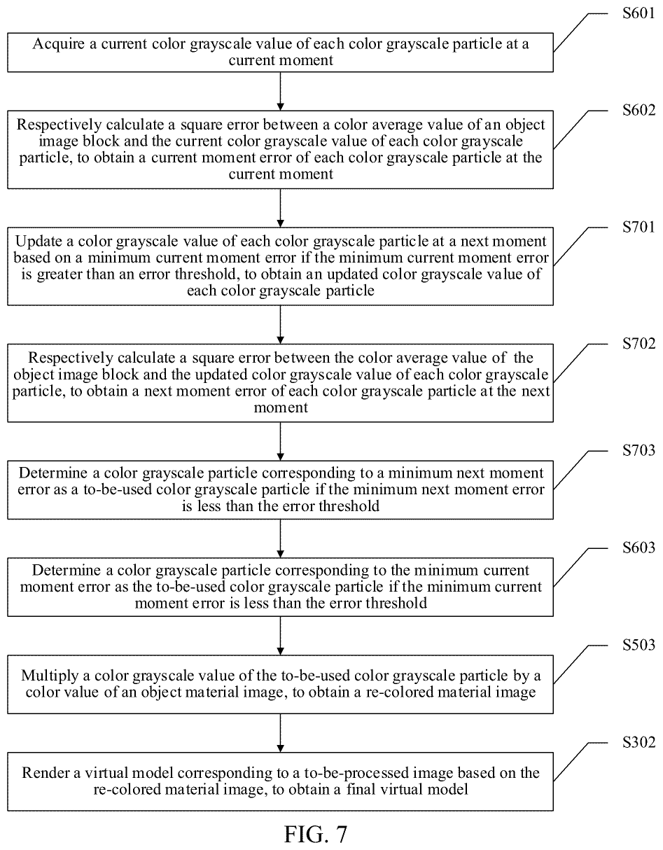

Based on the foregoing embodiment corresponding to FIG. 6, in another embodiment of the material extraction method provided in some embodiments, as shown in FIG. 7, after operation S602 of respectively calculating a square error between the color average value of the object image block and the current color grayscale value of each color grayscale particle, to obtain a current moment error of each color grayscale particle at the current moment, the method further includes:
S701: Update a color grayscale value of each color grayscale particle at a next moment based on a minimum current moment error if the minimum current moment error is greater than an error threshold, to obtain an updated color grayscale value of each color grayscale particle.
S702: Respectively calculate a square error between the color average value of the object image block and the updated color grayscale value of each color grayscale particle, to obtain a next moment error of each color grayscale particle at the next moment.
S703: Determine a color grayscale particle corresponding to a minimum next moment error as the to-be-used color grayscale particle if the minimum next moment error is less than the error threshold.

In some embodiments, after the minimum current moment error is acquired, the minimum current moment error may be compared with the error threshold, and if the minimum current moment error is greater than the error threshold, the color grayscale value of each color grayscale particle at the next moment may be updated based on the minimum current moment error, to obtain the updated color grayscale value of each color grayscale particle. Further, the square error between the color average value of the object image block and the updated color grayscale value of each color grayscale particle is respectively calculated, to obtain the next moment error of each color grayscale particle at the next moment. Then, the next moment error is compared with the error threshold, and if a minimum next moment error is less than the error threshold, a color grayscale particle corresponding to the minimum next moment error may be determined as the to-be-used color grayscale particle.

As shown in FIG. 15, after the current global optimal estimated particle is found, the minimum current moment error may be compared with the error threshold, and if the minimum current moment error is greater than the error threshold, the current global optimal estimated particle is a color grayscale particle that is most dissimilar to the object image block in color. Therefore, as shown in FIG. 15, the color grayscale value of each color grayscale particle at the next moment may be continuously updated based on the minimum current moment error corresponding to the current global optimal estimated particle. Specifically, the grayscale value is updated by using formula (2) and formula (3) based on the minimum current moment error corresponding to the current global optimal estimated particle and the color grayscale value of each color grayscale particle, to acquire the updated color grayscale value pᵢ^{t+1} at the next moment:

$${p}_{i}^{t + 1} = {p}_{i}^{t} + {q}_{i}^{t + 1} ; \qquad ( 2 )$$

$$and$$

$${q}_{i}^{t + 1} = {q}_{i}^{t} + {c}_{1} \times r a n d ( 0 , 1 ) \times ( {o}_{i}^{t} - {p}_{i}^{t} ) + {c}_{2} \times r a n d ( 0 , 1 ) \times ( {g}_{t} - {p}_{i}^{t} ) , \qquad ( 3 )$$

where c₁ and c₂ are learning factors, oᵢ^{t} is an optimal value of the color grayscale particle i from the moment t=0 to a current time t, namely, oᵢ^{t}=argmax_{j∈[0,t]}(sᵢ^{j}), gₜ is a global optimal value at the current moment t, namely, gₜ=argminᵢ(h(pᵢ^{t})−h(v))², and qᵢ^{t} is updated momentum of the color grayscale particle i at the current moment t.

After the updated color grayscale value of each color grayscale particle at the next moment is acquired, the square error between the color average value of the object image block and the updated color grayscale value of each color grayscale particle may be respectively calculated by using (h(pᵢ^{t+1})−h(v))², to acquire the next moment error of each color grayscale particle at the next moment.

Next, a color grayscale particle with a minimum next moment error (namely, a minimum next moment square error) may be found as a current global optimal estimated particle, namely, gₜ₊₁=argminᵢ(h(pᵢ^{t+1})−h(v))².

As shown in FIG. 15, after the global optimal estimated particle at the next moment is found, the minimum next moment error may be compared with the error threshold, and if the minimum next moment error is less than the error threshold, the global optimal estimated particle at the next moment is the color grayscale particle that is most similar to or consistent with the object image block in color, namely, the to-be-used color grayscale particle. Otherwise, if the minimum next moment error is greater than the error threshold, as shown in FIG. 15, the operations of updating the color grayscale value of each color grayscale particle at the next moment, respectively calculating the square error between the color average value of the object image block and the updated next moment color grayscale value of each color grayscale particle, and comparing the minimum next moment error with the error threshold may be repeatedly performed, to find the global optimal estimated particle that is most similar or consistent with the object image block in color, namely, the to-be-used color grayscale particle. Subsequently, the color grayscale value of the to-be-used color grayscale particle may be multiplied by the color value of the object material image, to obtain the re-coloration result, and the object material image may be re-colored based on the re-coloration result, to acquire the re-colored material image.

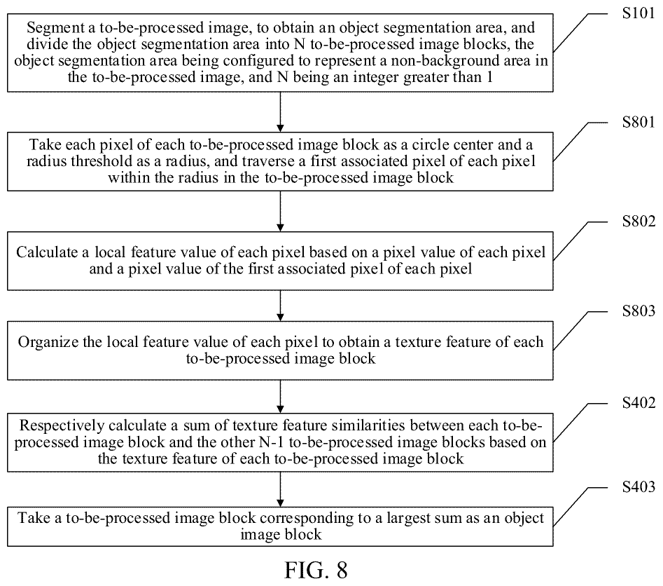

Based on the foregoing embodiment corresponding to FIG. 4, in another embodiment of the material extraction method provided in some embodiments, as shown in FIG. 8, operation S401 of calculating a texture feature of each to-be-processed image block based on a pixel value of each pixel in each to-be-processed image block includes:
S801: Take each pixel of each to-be-processed image block as a circle center and a radius threshold as a radius, and traverse a first associated pixel of each pixel within the radius in the to-be-processed image block.
S802: Calculate a local feature value of each pixel based on the pixel value of each pixel and a pixel value of the first associated pixel of each pixel.
S803: Organize the local feature value of each pixel to obtain the texture feature of each to-be-processed image block.

In some embodiments, a method for calculating the texture feature of each to-be-processed image block may be as follows: each pixel of each to-be-processed image block may be taken as the circle center and the radius threshold is taken as the radius, and the first associated pixel of each pixel within the radius in the to-be-processed image block is traversed; further, the local feature value corresponding to each pixel is calculated based on the pixel value of each pixel and the pixel value of the first associated pixel of each pixel; and then the local feature value of each pixel is organized to obtain the texture feature of each to-be-processed image block.

In some embodiments, the method for calculating the texture feature of each to-be-processed image block may be as follows: each pixel (such as any pixel K) of each to-be-processed image block is taken as the circle center and using the radius threshold (such as a threshold R) is taken as the radius, and a pixel within a range taking K as the circle center and R as the radius in the to-be-processed image block is traversed and taken as the first associated pixel.

For the pixel K in the to-be-processed image, the texture feature corresponding to each pixel, namely, the local feature value, may be simply and efficiently calculated by using an LBP feature algorithm represented by formula (4), and a texture characteristic in the to-be-processed image block is better described based on the texture feature, whereby a characteristic of a building wall is better described:

$$L B P ( K ) = {\sum }_{j \leq Q} δ ( f ( K ) - f ( j ) ) \times {2}^{j} , \qquad ( 4 )$$

where δ is an activation impulse function, K is the pixel in the to-be-processed image block, and Q is a quantity of pixels within the range taking R as the radius and K as the circle center, and f(·) is the pixel value of the pixel in the to-be-processed image block.

After the local feature value of each pixel is acquired, the local feature value of each pixel may be organized according to a location of each pixel in the to-be-processed image, to acquire the texture feature of each to-be-processed image block.

In some embodiments, for each pixel in the to-be-processed image block, the local feature value of the pixel may be determined based on both the pixel value of the pixel and the pixel value of the first associated pixel of the pixel. The impact of a surrounding pixel of the pixel on the local feature value of the pixel is considered, whereby the texture characteristic in the to-be-processed image block may be better described, and the characteristic of the object may be better described.

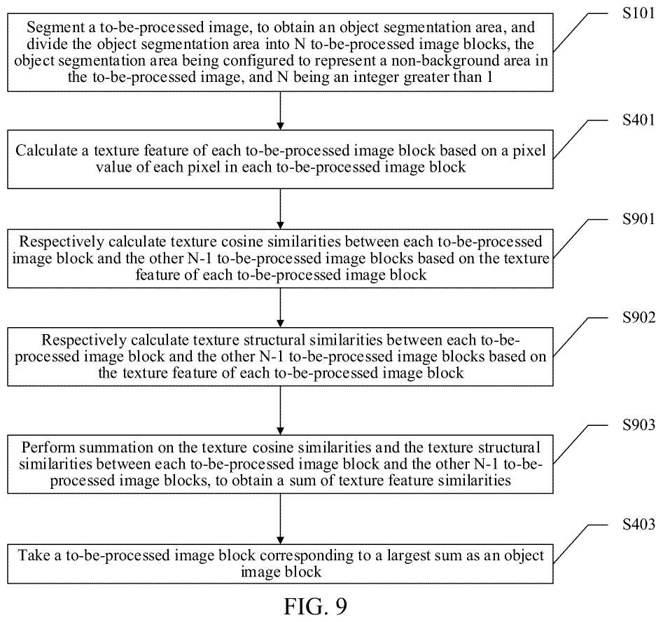

Based on some embodiments corresponding to FIG. 4, in another embodiment of the material extraction method provided by some embodiments, as shown in FIG. 9, the texture feature similarity includes a texture cosine similarity and a texture SSIM; and operation S402 of respectively calculating a sum of texture feature similarities between each to-be-processed image block and the other N−1 to-be-processed image blocks based on the texture feature of each to-be-processed image block includes:
S901: Respectively calculate texture cosine similarities between each to-be-processed image block and the other N−1 to-be-processed image blocks based on the texture feature of each to-be-processed image block.
S902: Respectively calculate texture SSIMs between each to-be-processed image block and the other N−1 to-be-processed image blocks based on the texture feature of each to-be-processed image block.
S903: Perform summation on the texture cosine similarities and the texture SSIMs between each to-be-processed image block and the other N−1 to-be-processed image blocks, to obtain the sum of the texture feature similarities.

In some embodiments, because the cosine similarity can measure a statistical similarity between two feature vectors, and the SSIM can measure a visual similarity between two image features, in some embodiments, the texture similarity may be represented as the texture cosine similarity and the texture SSIM. Therefore, after the texture feature of each to-be-processed image block is acquired, first, the texture cosine similarities between each to-be-processed image block and the other N−1 to-be-processed image blocks may be respectively calculated, and meanwhile, the texture SSIMs between each to-be-processed image block and the other N−1 to-be-processed image blocks are calculated; and then, summation is performed on the texture cosine similarities and the texture SSIMs between each to-be-processed image block and the other N−1 to-be-processed image blocks to obtain the sum of the texture feature similarities.

In some embodiments, after the texture feature of each to-be-processed image block is acquired, the feature mutual information between the to-be-processed image blocks may be calculated. Specifically, it is assumed that LBP feature expressions of a to-be-processed image block i and a to-be-processed image block j are Qᵢ and Qⱼ, respectively, a texture cosine similarity, namely, cos(Qᵢ, Qⱼ), between the to-be-processed image block i and the to-be-processed image block j may be calculated by using a cosine similarity algorithm. Similarly, the texture cosine similarity between each to-be-processed image block and another to-be-processed image block may be calculated.

Next, a texture SSIM, namely, SSIM(Qᵢ, Qⱼ), between the to-be-processed image block i and the to-be-processed image block j may be calculated by using an SSIM algorithm. Similarly, the texture SSIM between each to-be-processed image block and another to-be-processed image block may be calculated.

Then, a correlation between the to-be-processed image block i and the to-be-processed image block j may be described by using a sum of the texture cosine similarity and the texture SSIM that correspond to the to-be-processed image block i and the to-be-processed image block j, that is, SIM(i, j)=cos(Qᵢ, Qⱼ)+SSIM(Qᵢ, Qⱼ). Similarly, summation may be performed on the texture cosine similarities and the texture SSIMs between each to-be-processed image block and the other N−1 to-be-processed image blocks, to obtain the sum of the texture feature similarities corresponding to each to-be-processed image block. Subsequently, an optimal matched image block may be quickly and accurately selected as the object image block based on the sum of the texture feature similarities corresponding to each to-be-processed image block.

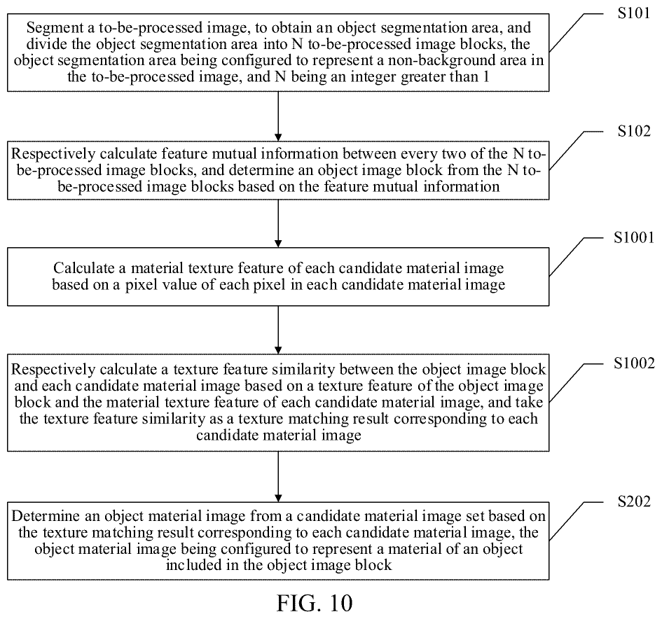

Based on the foregoing embodiment corresponding to FIG. 2, in another embodiment of the material extraction method provided in some embodiments, as shown in FIG. 10, the operation of respectively performing texture matching on the object image block and each candidate material image in a candidate material image set, to obtain a texture matching result corresponding to each candidate material image includes:
S1001: Calculate a material texture feature of each candidate material image based on a pixel value of each pixel in each candidate material image.
S1002: Respectively calculate a texture feature similarity between the object image block and each candidate material image based on a texture feature of the object image block and the material texture feature of each candidate material image, and take the texture feature similarity as the texture matching result corresponding to each candidate material image.

In some embodiments, when texture matching is respectively performed on the object image block and each candidate material image in the candidate material image set, first, the material texture feature of each candidate material image may be calculated based on the pixel value of each pixel in each candidate material image; and then, the texture feature similarity between the object image block and each candidate material image may be respectively calculated based on the texture feature of the object image block and the material texture feature of each candidate material image, and the texture feature similarity is taken as the texture matching result corresponding to each candidate material image.

In some embodiments, when texture matching is respectively performed on the object image block and each candidate material image in the candidate material image set, the material texture feature of each candidate material image may be first calculated based on the pixel value of each pixel in each candidate material image. Specifically, first, each pixel (such as a pixel K) of each candidate material image may be taken as a circle center, a radius threshold (such as a radius R) may be taken as a radius, and a second associated pixel corresponding to each pixel within the radius in each candidate material image is traversed; further, a local feature value corresponding to each pixel is calculated by using an LBP feature algorithm based on the pixel value of each pixel and a pixel value of the second associated pixel corresponding to each pixel; and then the local feature value of each pixel is organized to obtain the material texture feature of each candidate material image.

After the material texture feature of each candidate material image is acquired, the texture feature similarity between the object image block and each candidate material image is respectively calculated based on the texture feature of the object image block and the material texture feature of each candidate material image. Specifically, it is assumed that LBP feature expressions of an object image block x and each candidate material image y are Qₓ and Q_{y}, respectively, and a texture cosine similarity, namely, cos (Qₓ, Q_{y}), between the object image block x and each candidate material image y may be calculated by using a cosine similarity algorithm.

Next, a texture SSIM, namely, SSIM (Qₓ, Q_{y}), between the object image block x and each candidate material image y may be calculated by using an SSIM algorithm.

Then, a sum, namely, SIM(x, y)=cos(Qₓ, Q_{y})+SSIM(Qₓ, Q_{y}), of the texture cosine similarity and the texture SSIM that correspond to the object image block x and each candidate material image y is taken as a texture feature similarity, which describe a correlation, namely, the texture matching result corresponding to each candidate material image, between the object image block x and each candidate material image y.

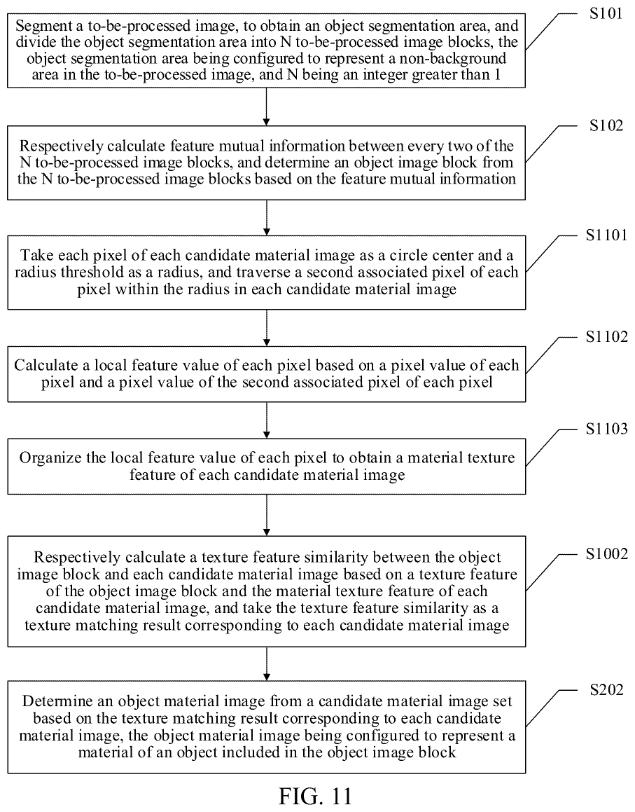

Based on the foregoing embodiment corresponding to FIG. 10, in another embodiment of the material extraction method provided in some embodiments, as shown in FIG. 11, operation S1001 of calculating a material texture feature of each candidate material image based on a pixel value of each pixel in each candidate material image includes:
S1101: Take each pixel of each candidate material image as a circle center and a radius threshold as a radius, and traverse a second associated pixel of each pixel within the radius in each candidate material image.
S1102: Calculate a local feature value of each pixel based on the pixel value of each pixel and a pixel value of the second associated pixel of each pixel.
S1103: Organize the local feature value of each pixel to obtain the material texture feature of each candidate material image.

In some embodiments, a method for calculating the material texture feature of each candidate material image may be as follows: each pixel of each candidate material image is taken as the circle center, the radius threshold is taken as the radius, the second associated pixel corresponding to each pixel within the radius in each candidate material image is traversed, and the local feature value corresponding to each pixel is calculated based on the pixel value of each pixel and the pixel value of the second associated pixel corresponding to each pixel; and then the local feature value of each pixel is organized to obtain the material texture feature of each candidate material image.

In some embodiments, the method for calculating the material texture feature of each candidate material image may be as follows: each pixel (such as any pixel K) of each candidate material image is taken as the circle center, the radius threshold (such as a threshold R) is taken as the radius, and a pixel within a range taking K as the circle center and taking R as the radius in each candidate material image is traversed as the second associated pixel.

Next, for the pixel K in each candidate material image, the texture feature, namely, the local feature value, corresponding to each pixel may be calculated simply and efficiently by using the LBP feature algorithm represented by formula (4).

When formula (4) is adopted, δ is the activation impulse function, the current K is the pixel in each candidate material image, the current Q is a quantity of pixels within the range taking the current pixel K as the circle center and taking R as the radius, and the current f(·) is the pixel value of the pixel in each candidate material image.

After the local feature value of each pixel on each candidate material image is acquired, the local feature value of each pixel may be organized according to a location of each pixel in each candidate material image, to acquire the material texture feature of each candidate material image.

In some embodiments, for each pixel in the candidate material image, the local feature value of the pixel may be determined based on both the pixel value of the pixel and the pixel value of the second associated pixel of the pixel. The impact of a surrounding pixel of the pixel on the local feature value of the pixel is considered, whereby a texture characteristic in the to-be-processed image block may be better described, and a characteristic of the object may be better described.

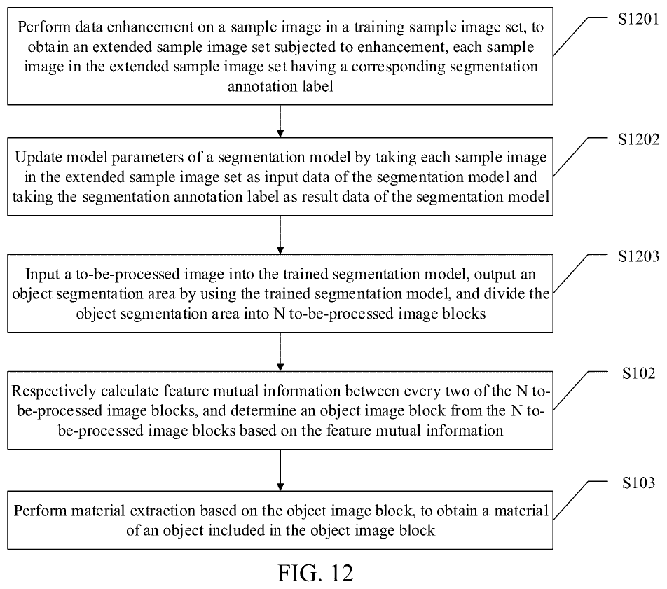

Based on the foregoing embodiment corresponding to FIG. 2, in another embodiment of the material extraction method provided in some embodiments, as shown in FIG. 12, before operation S101 of segmenting a to-be-processed image, to obtain an object segmentation area, and dividing the object segmentation area into N to-be-processed image blocks, the method further includes: S1201 to S1203.
S1201: Perform data enhancement on a sample image in a training sample image set, to obtain an extended sample image set subjected to enhancement, each sample image in the extended sample image set having a corresponding segmentation annotation label.
S1202: Update model parameters of a segmentation model by taking each sample image in the extended sample image set as input data of the segmentation model and taking the segmentation annotation label as result data of the segmentation model.
S1203: Input the to-be-processed image into the trained segmentation model, output the object segmentation area by using the trained segmentation model, and divide the object segmentation area into the N to-be-processed image blocks.

In some embodiments, to better acquire the object segmentation area, in some embodiments, data enhancement may be performed on the sample image in the training sample image set, to obtain the extended sample image set subjected to enhancement; and then the model parameters of the segmentation model are updated by taking each sample image in the extended sample image set as the input data of the segmentation model and taking the segmentation annotation label as the result data of the segmentation model, to acquire the trained segmentation model. Subsequently, the to-be-processed image may be inputted into the trained segmentation model, the object segmentation area is outputted by using the trained segmentation model, and the object segmentation area is divided into the N to-be-processed image blocks.

A wall extraction module shown in FIG. 14 may be configured to segment a wall area, namely, the object segmentation area, from the input to-be-processed image. The segmentation model may be an AI neural network-based segmentation model shown in FIG. 14, such as a fully convolutional neural network U-Net model or a fully convolutional network (FCN) for image segmentation.

The segmentation annotation label is an annotation label corresponding to each sample image in the extended sample image set. An image in each image-annotation pair in a series of image-annotation pairs is the sample image (such as a building image), the annotation is a segmentation mask image whose size is the same as that of the image, and a corresponding value may be represented as 0 or 1, where 0 represents that the sample image is a background, and 1 represents that the sample image is a building wall.

The training sample image set may be from pixel-level annotation data (such as pixel-level annotation data of a wall), and may be obtained from a public data source such as a creative management platform (CMP), a distributed database RueMonge, an enterprise cloud platform (ECP), or an enterprise trust Intranet manager solutions (eTRIMS). That is, the public data may be collected, to construct a wall segmentation data set, namely, the training sample image set, of a series of image-segmentation annotation label pairs with rich sources.

In some embodiments, to enhance the diversity of the training sample image set to help the segmentation model better learn a capability of distinguishing a background from a target object, and enhance generalization of the segmentation model to enable the segmentation model to better deal with various complex photographing conditions in an actual application scenario, in some embodiments, data enhancement may be respectively performed on each training image in the training sample image set based on a plurality of policies, including processing approaches such as random color transformation, image contrast transformation, exposure transformation, and random rotation, to obtain the extended sample image set subjected to enhancement, and a corresponding segmentation annotation label is matched with each sample image in the extended sample image set in an image-annotation pair manner.

In some embodiments, each sample image in the extended sample image set may be taken as the input data of the segmentation model, a predicted segmentation result corresponding to each sample image is outputted by using the segmentation model; and then the segmentation annotation label may be taken as the result data of the segmentation model. That is, a loss (such as cross entropy or information entropy) may be calculated based on the predicted segmentation result corresponding to each sample image and the segmentation annotation label corresponding to each sample image, and the model parameters of the segmentation model are updated based on the calculated loss value, to acquire the trained segmentation model.

After the trained segmentation model is acquired, the to-be-processed image may be inputted into the trained segmentation model, the object segmentation area is outputted by using the trained segmentation model, and the object segmentation area is divided into the N to-be-processed image blocks.

In some embodiments, segmentation is performed by using the trained segmentation model, whereby the N to-be-processed image blocks may be obtained more quickly and accurately.

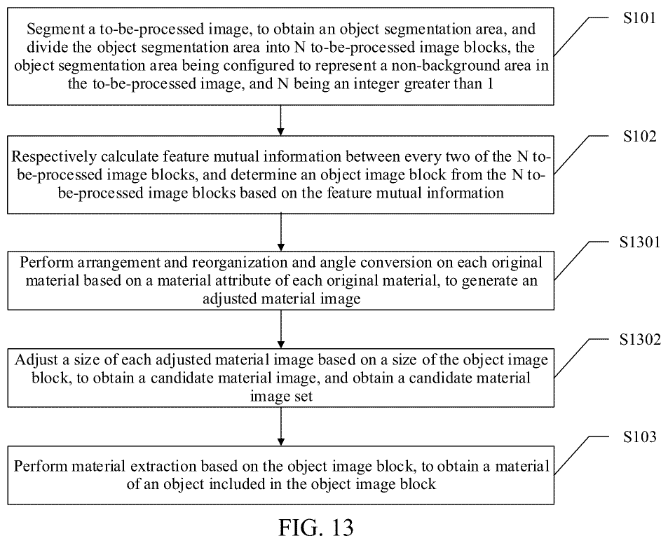

Based on the foregoing embodiment corresponding to FIG. 2, in another embodiment of the material extraction method provided in some embodiments, as shown in FIG. 13, before operation S103 of respectively performing texture matching on the object image block and each candidate material image in a candidate material image set, to obtain a texture matching result corresponding to each candidate material image, the method further includes:
S1301: Perform arrangement and reorganization and angle conversion on each original material based on a material attribute of each original material, to generate an adjusted material image.
S1302: Adjust a size of each adjusted material image based on a size of the object image block, to obtain the candidate material image, and obtain the candidate material image set.

In some embodiments, to better perform texture matching on the object image block and each candidate material image in the candidate material image set, before performing texture matching on the object image block and each candidate material image in the candidate material image set, in some embodiments, first, material adjustment may be performed on the original material, that is, processing, such as arrangement and reorganization and angle conversion, is performed on each original material based on the material attribute of each original material, to generate the adjusted material image; and then the size of each adjusted material image is adjusted based on the size of the object image block, to obtain the candidate material image corresponding to each adjusted material image. and obtain the candidate material image set.

A description is made by using an example in which an object is a wall. In an actual application scenario, sizes and directions of wall units in a building are usually different (for example, two walls are brick walls, but sizes and arrangement directions of bricks may be different). Therefore, in some embodiments, for each original material, arrangement and reorganization and different angle conversions (namely, conversions of a material attribute parameter) may be first performed on each original material by using a material adjustment function in the UE based on the material attribute of the original material, to generate several material images with different uv sizes and different rotation angles, namely, the adjusted material images.

To better perform texture matching on the object image block and each candidate material image in the candidate material image set, the size of each adjusted material image may be adjusted, based on the size of the object image block, to be consistent with that of the object image block, that is, to obtain the candidate material image, and the candidate material images are collected to obtain the candidate material image set.

By the foregoing method, the candidate material image that adapts to different arrangements and angles and that is consistent with the object image block in size may be obtained. In this way, the object image block is better matched with the candidate material image, to improve accuracy and efficiency of matching.

A material extraction apparatus in this application is described below in detail. FIG. 16 is a schematic diagram of a material extraction apparatus according to some embodiments. A material extraction apparatus 20 includes:
an acquisition unit 201, configured to segment a to-be-processed image, to obtain an object segmentation area, and divide the object segmentation area into N to-be-processed image blocks, the object segmentation area being configured to represent a non-background area in the to-be-processed image, and N being an integer greater than 1;
a determination unit 202, configured to respectively calculate feature mutual information between every two of the N to-be-processed image blocks, and determine an object image block from the N to-be-processed image blocks based on the feature mutual information; and
a processing unit 203, configured to perform material extraction based on the object image block, to obtain a material of an object included in the object image block.

In some embodiments, the processing unit 203 is configured to respectively perform texture matching on the object image block and each candidate material image in a candidate material image set, to obtain a texture matching result corresponding to each candidate material image; and
determine an object material image from the candidate material image set based on the texture matching result corresponding to each candidate material image, the object material image being configured to represent the material of the object included in the object image block.

In some embodiments, based on some embodiments corresponding to FIG. 16, in another embodiment of the material extraction apparatus provided in some embodiments,
the processing unit 203 is further configured to re-color the object material image based on a color value of the object image block, to obtain a re-colored material image; and
render a virtual model corresponding to the to-be-processed image based on the re-colored material image, to obtain a final virtual model.

In some embodiments, based on the foregoing embodiment corresponding to FIG. 16, in another embodiment of the material extraction apparatus provided in some embodiments, the determination unit 202 may be configured to:
calculate a texture feature of each to-be-processed image block based on a pixel value of each pixel in each to-be-processed image block;
respectively calculate a sum of texture feature similarities between each to-be-processed image block and the other N−1 to-be-processed image blocks based on the texture feature of each to-be-processed image block; and
take a to-be-processed image block corresponding to a largest sum as the object image block.

In some embodiments, based on the foregoing embodiment corresponding to FIG. 16, in another embodiment of the material extraction apparatus provided in some embodiments, the determination unit 202 may be configured to:
smooth the object image block, to obtain a color value corresponding to each pixel in the object image block, and calculate a color average value of the object image block based on the color value corresponding to each pixel in the object image block;
determine a to-be-used color grayscale particle from M randomly initialized color grayscale particles based on the color average value of the object image block, M being an integer greater than or equal to 1; and
multiply a color grayscale value of the to-be-used color grayscale particle by a color value of the object material image, to obtain the re-colored material image.

In some embodiments, based on the foregoing embodiment corresponding to FIG. 16, in another embodiment of the material extraction apparatus provided in some embodiments, the determination unit 202 may be configured to:
acquire a current color grayscale value of each color grayscale particle at a current moment;
respectively calculate a square error between the color average value of the object image block and the current color grayscale value of each color grayscale particle, to obtain a current moment error of each color grayscale particle at the current moment; and
determine a color grayscale particle corresponding to a minimum current moment error as the to-be-used color grayscale particle if the minimum current moment error is less than an error threshold.

In some embodiments, based on some embodiments corresponding to FIG. 16, in another embodiment of the material extraction apparatus provided in some embodiments,
the processing unit 203 is further configured to update a color grayscale value of each color grayscale particle at a next moment based on a minimum current moment error if the minimum current moment error is greater than an error threshold, to obtain an updated color grayscale value of each color grayscale particle; and
respectively calculate a square error between the color average value of the object image block and the updated color grayscale value of each color grayscale particle, to obtain a next moment error of each color grayscale particle at the next moment; and
the determination unit 202 is further configured to determine a color grayscale particle corresponding to a minimum next moment error as the to-be-used color grayscale particle if the minimum next moment error is less than the error threshold.

In some embodiments, based on the foregoing embodiment corresponding to FIG. 16, in another embodiment of the material extraction apparatus provided in some embodiments, the processing unit 203 may be configured to:
take each pixel of each to-be-processed image block as a circle center and a radius threshold as a radius, and traverse a first associated pixel of each pixel within the radius in the to-be-processed image block;
calculate a local feature value of each pixel based on the pixel value of each pixel and a pixel value of the first associated pixel of each pixel; and
organize the local feature value of each pixel to obtain the texture feature of each to-be-processed image block.

In some embodiments, based on the foregoing embodiment corresponding to FIG. 16, in another embodiment of the material extraction apparatus provided in some embodiments, the processing unit 203 may be configured to:
respectively calculate texture cosine similarities between each to-be-processed image block and the other N−1 to-be-processed image blocks based on the texture feature of each to-be-processed image block;
respectively calculate texture SSIMs between each to-be-processed image block and the other N−1 to-be-processed image blocks based on the texture feature of each to-be-processed image block; and
perform summation on the texture cosine similarities and the texture SSIMs between each to-be-processed image block and the other N−1 to-be-processed image blocks, to obtain the sum of the texture feature similarities.

In some embodiments, based on the foregoing embodiment corresponding to FIG. 16, in another embodiment of the material extraction apparatus provided in some embodiments, the processing unit 203 may be configured to:
calculate a material texture feature of each candidate material image based on a pixel value of each pixel in each candidate material image; and
respectively calculate a texture feature similarity between the object image block and each candidate material image based on a texture feature of the object image block and the material texture feature of each candidate material image, and take the texture feature similarity as the texture matching result corresponding to each candidate material image.

In some embodiments, based on the foregoing embodiment corresponding to FIG. 16, in another embodiment of the material extraction apparatus provided in some embodiments, the processing unit 203 may be configured to:
take each pixel of each candidate material image as a circle center and a radius threshold as a radius, and traverse a second associated pixel of each pixel within the radius in each candidate material image;
calculate a local feature value of each pixel based on the pixel value of each pixel and a pixel value of the second associated pixel of each pixel; and
organize the local feature value of each pixel to obtain the material texture feature of each candidate material image.

In some embodiments, based on some embodiments corresponding to FIG. 16, in another embodiment of the material extraction apparatus provided in some embodiments,
the processing unit 203 is further configured to perform data enhancement on a sample image in a training sample image set, to obtain an extended sample image set subjected to enhancement, each sample image in the extended sample image set having a corresponding segmentation annotation label; and
update model parameters of a segmentation model by taking each sample image in the extended sample image set as input data of the segmentation model and taking the segmentation annotation label as result data of the segmentation model; and
the acquisition unit 201 may be configured to:
input the to-be-processed image into the trained segmentation model, output the object segmentation area by using the trained segmentation model, and divide the object segmentation area into the N to-be-processed image blocks.

In some embodiments, based on some embodiments corresponding to FIG. 16, in another embodiment of the material extraction apparatus provided in some embodiments,
the acquisition unit 201 is further configured to perform arrangement and reorganization and angle conversion on each original material based on a material attribute of each original material, to generate an adjusted material image; and
the processing unit 203 is further configured to adjust a size of each adjusted material image based on a size of the object image block, to obtain the candidate material image, and obtain the candidate material image set.

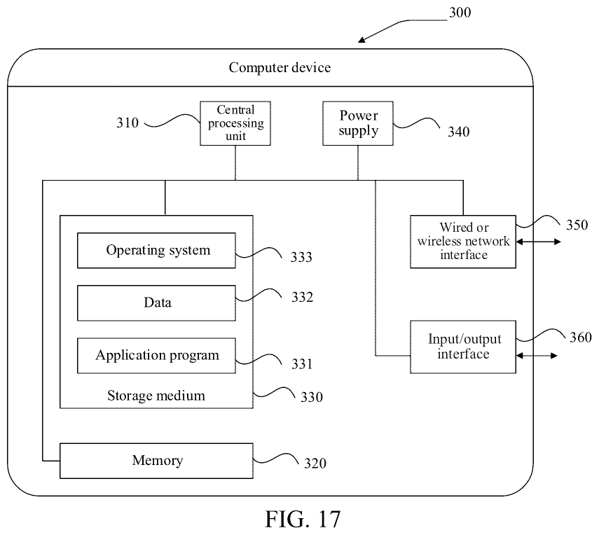

In another aspect, this application provides a computer device. FIG. 17 is a schematic structural diagram of a computer device according to some embodiments. A computer device 300 may vary significantly due to different configurations or performance, and may include one or more central processing units (CPUs) 310 (such as one or more processors), a memory 320, and one or more storage media 330 (such as one or more mass storage devices) that store an application program 331 or data 332. The memory 320 and the storage medium 330 may be transient storage or persistent storage. The program stored in the storage medium 330 may include one or more modules (not shown in the figure), and each module may include a series of instruction operations for the computer device 300. Much further, the CPU 310 may be configured to communicate with the storage medium 330, and perform, on the computer device 300, the series of instruction operations in the storage medium 330.

The computer device 300 may further include one or more power supplies 340, one or more wired or wireless network interfaces 350, one or more input/output interfaces 360, and/or one or more operating systems 333, such as Windows Server™, Mac OS X™, Unix™, Linux™, or FreeBSD™.

The computer device 300 is further configured to perform the operations in some embodiments respectively corresponding to FIG. 2 to FIG. 13.

In another aspect, this application provides a computer-readable storage medium, which has a computer program stored therein. A processor executes the computer program to implement the operations in some embodiments respectively corresponding to FIG. 2 to FIG. 13.

In another aspect, this application provides a computer program product, which includes a computer program. A processor executes the computer program to implement the operations in some embodiments respectively corresponding to FIG. 2 to FIG. 13.

Those skilled in the art may clearly understand that for convenience and conciseness of description, working processes of the foregoing system, apparatus, and units may refer to the corresponding processes in the foregoing method embodiments.

In the several embodiments provided in this application, the disclosed system, apparatus, and method may be implemented in other manners. For example, the foregoing apparatus embodiments are merely examples. For example, the foregoing units are divided according to the logical functions and may be divided in another manner in actual use. For example, a plurality of units or components may be combined or integrated into another system, or some features may be omitted or not performed. In addition, the displayed or discussed mutual coupling or direct coupling or communication connection may be implemented through interfaces. The indirect coupling or communication connection between the apparatuses or units may be implemented in electronic, mechanical, or another form.

The units described as separate components may or may not be physically separated. The components displayed as units may or may not be physical units, that is, may be located in one place or may be distributed over a plurality of network units. Some or all of the units may be selected according to actual may achieve the objectives of the solutions of the embodiments.

In addition, the functional units in some embodiments may be integrated into one processing unit, or each of the units may be physically separated, or two or more units may be integrated into one unit. The integrated unit may be implemented in the form of hardware, or may be implemented in the form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the related art, or all or some of the technical solutions may be implemented in the form of a software product. The computer software product is stored in one storage medium and includes several instructions for instructing a computer device (which may be a personal computer, a server, a network device, or the like) to perform all or some of the operations of the methods described in some embodiments. The foregoing storage medium includes: any medium that can store program code, such as a Universal Serial Bus (USB) flash drive, a movable hard disk drive, a read-only memory (ROM), a random-access memory (RAM), a magnetic disk, or an optical disc.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A method for extracting material information, performed by a computer device, the method comprising:
segmenting an image to obtain an object segmentation area representing a non-background area in the image;
dividing the object segmentation area into N image blocks, N being an integer greater than 1;
calculating feature mutual information between every two of the N image blocks;
determining an object image block from the N image blocks based on the feature mutual information; and
extracting, based on the object image block, material information associated with an object in the object image block.

2. The method according to claim 1, wherein the extracting, based on the object image block, material information of an object in the object image block comprises:
performing texture matching between the object image block and each candidate material image in a candidate material image set to obtain a texture matching for each candidate material image; and
determining, based on the texture matching result, an object material image from the candidate material image set, the object material image representing the material information associated with the object in the object image block.

3. The method according to claim 2, further comprising:
re-coloring the object material image based on a color value of the object image block to obtain a re-colored material image; and
rendering, based on the re-colored material image, a virtual model corresponding to the image to obtain a final virtual model.

4. The method according to claim 1,
wherein the feature mutual information comprises a texture feature similarity; and
wherein the calculating feature mutual information between every two of the N image blocks; determining an object image block from the N image blocks based on the feature mutual information comprises:
calculating a texture feature of each image block based on a pixel value of each pixel in each image block;
calculating a sum of texture feature similarities between each image block and N−1 image blocks based on the texture feature of each image block; and
selecting an image block corresponding to a largest sum as the object image block.

5. The method according to claim 3, wherein the re-coloring the object material image based on a color value of the object image block to obtain a re-colored material image comprises:
smoothing the object image block to obtain color values for pixels in the object image block,
calculating a color average value of the object image block based on the color values for pixels in the object image block;
selecting a color grayscale particle from M randomly initialized color grayscale particles based on the color average value of the object image block, M being an integer greater than or equal to 1; and
multiplying a color grayscale value of color grayscale particle by a color value of the object material image to obtain the re-colored material image.

6. The method according to claim 5, wherein the selecting a color grayscale particle from M randomly initialized color grayscale particles based on the color average value of the object image block comprises:
acquiring a current color grayscale value of each color grayscale particle at a current moment;
calculating a square error between the color average value of the object image block and the current color grayscale value of each color grayscale particle to obtain a current moment error for each color grayscale particle; and
selecting, from M randomly initialized color grayscale particles, a color grayscale particle corresponding to a minimum current moment error based on the minimum current moment error being less than an error threshold.

7. The method according to claim 6, further comprising:
updating a color grayscale value of each color grayscale particle based on the minimum current moment error being greater than an error threshold to obtain an updated color grayscale value of each color grayscale particle;
calculating a square error between the color average value of the object image block and the updated color grayscale value to obtain a next moment error of each color grayscale particle; and
selecting a color grayscale particle corresponding to a minimum next moment error based on the minimum next moment error being less than the error threshold.

8. The method according to claim 4, wherein the calculating a texture feature of each image block based on a pixel value of each pixel in each image block comprises:
determining each pixel of each image block as a circle center and a radius threshold as a radius;
identifying a first associated pixel for each pixel within the radius in the image block;
calculating a local feature value of each pixel based on the pixel value of each pixel and a pixel value of the first associated pixel; and
organizing the local feature value of each pixel to obtain the texture feature of each image block.

9. The method according to claim 4,
wherein the texture feature similarity comprises a texture cosine similarity and a texture structural similarity,
wherein the calculating a sum of texture feature similarities between each image block and N−1 image blocks based on the texture feature of each image block comprises:
calculating texture cosine similarities between each image block and the N−1 image blocks based on the texture feature of each image block;
calculating texture structural similarities between each image block and the N−1 image blocks based on the texture feature of each image block; and
summing the texture cosine similarities and the texture structural similarities between each image block and the N−1 image blocks to obtain the sum of the texture feature similarities.

10. The method according to claim 2, wherein the performing texture matching between the object image block and each candidate material image in a candidate material image set to obtain a texture matching for each candidate material image comprises:
calculating a material texture feature of each candidate material image based on a pixel value of each pixel in each candidate material image; and
calculating a texture feature similarity between the object image block and each candidate material image based on a texture feature of the object image block and the material texture feature of each candidate material image,
wherein the texture feature similarity serves as the texture matching result corresponding to each candidate material image.

11. The method according to claim 10, wherein the calculating a material texture feature of each candidate material image based on a pixel value of each pixel in each candidate material image comprises:
determining each pixel of each candidate material image as a circle center and a radius threshold as a radius;
identifying a second associated pixel for each pixel within the radius in each candidate material image;
calculating a local feature value of each pixel based on the pixel value of each pixel and a pixel value of the second associated pixel of each pixel; and
organizing the local feature value of each pixel to obtain the material texture feature of each candidate material image.

12. The method according to claim 1, before the dividing the object segmentation area into N image blocks, the method further comprising:
performing data enhancement on a sample image in a training sample image set to obtain an extended sample image set, each sample image having a segmentation annotation label; and
determining each sample image in the extended sample image set as input data of a segmentation model and the segmentation annotation label as result data of the segmentation model to update model parameters of the segmentation model; and
wherein the segmenting an image to obtain an object segmentation area representing a non-background area in the image and the dividing the object segmentation area into N image blocks comprises: inputting the image into the segmentation model;
outputting the object segmentation area based on the trained segmentation model; and
dividing the object segmentation area into the N image blocks.

13. The method according to claim 2, before the performing texture matching between the object image block and each candidate material image in a candidate material image set to obtain a texture matching for each candidate material image, the method further comprising:
performing at least one of arrangement, reorganization, or angle conversion on each original material based on a material attribute of each original material to generate an adjusted material image;
adjusting a size of each adjusted material image based on a size of the object image block to obtain the candidate material image; and
obtaining the candidate material image set.

14. An apparatus for extracting material information, comprising:
at least one memory configured to store program code; and
at least one processor configured to read the program code and operate as instructed by the program code, the program code comprising:
segmenting code configured to cause at least one of the at least one processor to segment an image to obtain an object segmentation area representing a non-background area in the image;
dividing code configured to cause at least one of the at least one processor to divide the object segmentation area into N image blocks, N being an integer greater than 1;
calculating code configured to cause at least one of the at least one processor to calculate feature mutual information between every two of the N image blocks;
determining code configured to cause at least one of the at least one processor to determine an object image block from the N image blocks based on the feature mutual information; and
extracting code configured to cause at least one of the at least one processor to extract, based on the object image block, material information associated with an object in the object image block.

15. The apparatus according to claim 14, wherein the extracting code is further configured to cause at least one of the at least one processor to:
perform texture matching between the object image block and each candidate material image in a candidate material image set to obtain a texture matching for each candidate material image; and
determine, based on the texture matching result, an object material image from the candidate material image set, the object material image representing the material information associated with the object in the object image block.

16. The apparatus according to claim 15, wherein the program code is further configured to cause at least one of the at least one processor to:
re-color the object material image based on a color value of the object image block to obtain a re-colored material image; and
render, based on the re-colored material image, a virtual model corresponding to the image to obtain a final virtual model.

17. The apparatus according to claim 14,
wherein the feature mutual information comprises a texture feature similarity; and
wherein the calculating code is further configured to cause at least one of the at least one processor to:
calculate a texture feature of each image block based on a pixel value of each pixel in each image block;
calculate a sum of texture feature similarities between each image block and N−1 image blocks based on the texture feature of each image block; and
wherein the determining code is further configured to cause at least one of the at least one processor to:
select an image block corresponding to a largest sum as the object image block.

18. The apparatus according to claim 16, wherein the program code is further configured to cause at least one of the at least one processor to:
smooth the object image block to obtain color values for pixels in the object image block,
calculate a color average value of the object image block based on the color values for pixels in the object image block;
select a color grayscale particle from M randomly initialized color grayscale particles based on the color average value of the object image block, M being an integer greater than or equal to 1; and
multiply a color grayscale value of color grayscale particle by a color value of the object material image to obtain the re-colored material image.

19. The apparatus according to claim 18, wherein the program code is further configured to cause at least one of the at least one processor to:
acquire a current color grayscale value of each color grayscale particle at a current moment;
calculate a square error between the color average value of the object image block and the current color grayscale value of each color grayscale particle to obtain a current moment error for each color grayscale particle; and
select, from M randomly initialized color grayscale particles, a color grayscale particle corresponding to a minimum current moment error based on the minimum current moment error being less than an error threshold.

20. A non-transitory computer-readable storage medium, storing computer code which, when executed by at least one processor, causes the at least one processor to at least:
segment an image to obtain an object segmentation area representing a non-background area in the image;
divide the object segmentation area into N image blocks, N being an integer greater than 1;
calculate feature mutual information between every two of the N image blocks;
determine an object image block from the N image blocks based on the feature mutual information; and
extract, based on the object image block, material information associated with an object in the object image block.
